(19) United States
(12) Patent Application Publication
(10) Pub. No.: US 2022/0129337 A1
(43) Pub. Date: Apr. 28, 2022

(54) Training a Model for Use with a Software Installation Process

(71) Applicant: Telefonaktiebolaget LM Ericsson (publ), Stockholm (SE)

(72) Inventors: Nikolas Hermanns, Heinsberg (DE); Jan-Erik Mångs, Solna (SE); Stefan Behrens, Herzogenrath (DE)

(21) Appl. No.: 17/431,272

(22) PCT Filed: Feb. 21, 2019
(86) PCT No.: PCT/EP2019/054389

§ 371 Date: Aug. 16, 2021

(51) Int. Cl. G06F 11/07; G06F 8/65; G06K 9/62; G06N 20/00

(52) U.S. Cl. CPC G06F 11/0709; G06F 11/0781; G06F 11/079; G06N 20/00; G06F 8/65; G06K 9/6256; G06F 11/0772

(57) ABSTRACT

There is provided a method of training a model for use with a software installation process. A software installation process is run a plurality of times (102). Each time the software installation process is run, one parameter in a set of parameters with which the software installation process is rum is changed to generate a respective software installation process output (104). Each software installation process output is used with its respective set of parameters to train a model (106). The model is trained to identify one or more parameters that are a cause of a failed software installation process based on the output of the failed software installation process.

### TECHNICAL FIELD

The present idea relates to a method of training a model for use with a software installation process, a method of using the trained model with a software installation process, and systems configured to operate in accordance with those methods.

### BACKGROUND

There are many software products available for users to install on their devices. However, the variety of configuration and hardware options that are available for those software products means that an error in the software installation process used to install the software products is highly likely and this makes it almost impossible for a software installation process to be completed successfully. Moreover, an incorrect configuration or wrongly setup hardware is very common and can be time consuming to troubleshoot. This is particularly the case for an untrained user (e.g. a customer) who is not familiar with a software product, since such a user would not know which log file and system status to check in the case of a failed software installation process.

Currently, error messages and log file statements that are output following a failed software installation process are uninformative and difficult for an untrained user to understand. Also, a great deal of experience is needed to quickly find a solution to the issues that caused the software installation process failure. Thus, the untrained user often needs to invest a great deal of time in back and forth discussions with software installation experts to determine the errors that may have caused a software installation process to fail in order for those errors to be rectified to allow for a successful software installation process. Moreover, the determination of the errors that may have caused the software installation process failure usually requires manual-troubleshooting on the part of the user.

This time consuming procedure of long-lasting sessions with experts together with manual troubleshooting can be frustrating for the user. This is even more of an issue given the fact that there are many new hardware and configuration options being introduced in many areas. For example, many new hardware and configuration options are being introduced in the (e.g. distributed) Cloud environment, such as for the fifth generation (5G) mobile networks. In general, massive installers need to be built to deploy data centers for a Cloud environment and, most of the time, large configuration files (e.g. which describe the infrastructure of the Cloud environment or features installed in the Cloud environment) are used as an input for the installer to describe a desired output. Thus, software installation process failure that requires long-lasting sessions with experts together with manual troubleshooting can be particularly problematic in the Cloud environment.

As such, there is a need for an improved technique for troubleshooting software installation process failures, which is aimed at addressing the problems associated with existing techniques.

### SUMMARY

It is thus an object to obviate or eliminate at least some of the above disadvantages associated with existing techniques and provide an improved technique for troubleshooting software installation process failures.

Therefore, according to an aspect of the idea, there is provided a method of training a model for use with a software installation process. The method comprises running a software installation process a plurality of times and, each time the software installation process is run, changing one parameter in a set of parameters with which the software installation process is run to generate a respective software installation process output. The method also comprises using each software installation process output with its respective set of parameters to train a model. The model is trained to identify one or more parameters that are a cause of a failed software installation process based on the output of the failed software installation process.

The idea thus provides an improved technique for troubleshooting software installation process failures. The improved technique avoids the need for long-lasting sessions with experts together with manual troubleshooting. Instead, according to the idea, a model is trained in such a way as to identify one or more parameters that are a cause of a failed software installation process. This trained model thus advantageously enables the cause of a failed software installation process to be identified more quickly and without the need for manual troubleshooting on the part of a user (e.g. a customer).

In some embodiments, the method may comprise, in response to a failed software installation process, using the trained model to identify one or more parameters that are a cause of the failed software installation process based on the output of the failed software installation process. In this way, a trained model is used to identify one or more parameters that are a cause of a failed software installation process. This trained model enables the cause of a failed software installation process to be identified more quickly and without the need for manual troubleshooting on the part of a user (e.g. a customer).

In some embodiments, the method may comprise generating a label vector to represent the set of parameters. In this way, the parameters are provided in a format that can be easily processed by the model.

In some embodiments, the label vector may comprise a plurality of items, each item representative of a parameter in the set of parameters.

In some embodiments, each time one parameter in the set of parameters is changed, the item representative of the changed parameter in the set of parameters may have a first value and the items representative of all other parameters in the set of parameters may have a second value, wherein the second value is different to the first value. In this way, it is possible to readily identify which parameter in the set of parameters is changed.

In some embodiments, the method may comprise converting each software installation process output into a feature vector. In this way, the software installation process outputs are provided in a format that can be easily processed by the model.

In some embodiments, the feature vector may comprise a plurality of items and each item may be representative of a feature of the software installation process output and may have a value indicative of whether the item represents a particular feature of the software installation process output. In this way, it is possible to distinguish a software installation process output from other software installation process outputs.

In some embodiments, each item representative of the particular feature of the software installation process output may have a first value and each item representative of other features of the software installation process output may have a second value, wherein the second value is different to the first value. In this way, it is possible to readily identify (or recognise) the software installation process output, since the values of the items provide the software installation process output with a distinctive (or even unique) identifying characteristic.

In some embodiments, the model may be further trained to indicate a probability that the one or more identified parameters are the cause of the failed software installation process based on the output of the failed software installation process. In this way, it is possible to identify which of the one or more identified parameters is most responsible (or is the main cause) of the failed software installation process.

In some embodiments, the method may comprise further training the trained model based on feedback from a user. In some embodiments, the feedback from the user may comprise an indication of a failed software installation process output with its respective set of parameters. In this way, the model can be refined (or fine-tined) to thereby improve the reliability of the method in identifying one or more parameters that are a cause of the failed software installation process is improved. Moreover, it can be guaranteed that the cause of that same fault can be identified to other users. A user can advantageously make use of software installation process failures that have already been experienced by other users.

In some embodiments, the respective software installation process outputs may comprise one or more failed software installation process outputs. In this way, failed software installation process outputs are available for analysis, which can provide useful information on the software.

In some embodiments, the respective software installation process outputs may comprise one or more successful software installation process outputs. In this way, successful software installation process outputs are available for use in creating an anomaly database such that actual failed software installation process outputs can be identified more easily.

In some embodiments, the method may comprise filtering the failed software installation process outputs based on the successful software installation process outputs. In this way, the accuracy and reliability of the identification of the one or more parameters that are a cause of the failed software installation process is improved.

In some embodiments, the software installation process may be a software installation process that is run for the first time or an upgrade of previously run software installation process. Thus, the method can be applied at any stage.

According to another aspect of the idea, there is provided a system configured to operate in accordance with the method of training a model for use with a software installation process described earlier. In some embodiments, the system comprises processing circuitry and at least one memory for storing instructions which, when executed by the processing circuitry, cause the system to operate in accordance with the method of training a model for use with a software installation process described earlier. The system thus provides the advantages discussed earlier in respect of the method of training a model for use with a software installation process.

According to another aspect of the idea, there is provided a method of using a trained model with a software installation process. The method comprises running a software installation process with a set of parameters to generate an output and, in response to a failure of the software installation process, using a trained model to identify which one or more parameters in the set of parameters are a cause of the failed software installation process based on the output of the failed software installation process.

The idea thus provides an improved technique for troubleshooting software installation process failures. The improved technique avoids the need for long-lasting sessions with experts together with manual troubleshooting. Instead, according to the idea, a trained model is used to identify one or more parameters that are a cause of a failed software installation process. This trained model thus advantageously enables the cause of a failed software installation process to be identified more quickly and without the need for manual troubleshooting on the part of a user (e.g. a customer).

In some embodiments, the trained model may generate a label vector comprising a plurality of items and each item may be representative of a parameter in the set of parameters and may have a value indicative of whether the parameter causes the software installation process to fail. In this way, it is possible to easily and quickly identify which one or more parameters cause the software installation process to fail.

In some embodiments, the method may comprise using the trained model to indicate a probability that the one or more identified parameters are the cause of the failed software installation process based on the output of the failed software installation process. In this way, it is possible to identify which of the one or more identified parameters is most responsible (or is the main cause) of the failed software installation process.

In some embodiments, the trained model may generate a label vector comprising a plurality of items and each item may be representative of a parameter in the set of parameters and may have a value indicative of a probability that the parameter causes the software installation process to fail. In this way, it is possible to identify the extent to which each parameter is the cause of the failed software installation process.

In some embodiments, the failed software installation may be a failed software installation process that is run for the first time or a failed upgrade of previously run software installation process. Thus, the method can be applied at any stage.

According to another aspect of the idea, there is provided a system configured to operate in accordance with the method of using a trained model with a software installation process described earlier. In some embodiments, the system comprises processing circuitry and at least one memory for storing instructions which, when executed by the processing circuitry, cause the system to operate in accordance with the method of using a trained model with a software installation process described earlier. The system thus provides the advantages discussed earlier in respect of the method of using a trained model with a software installation process.

According to another aspect of the idea, there is provided a computer program comprising instructions which, when executed by processing circuitry, cause the processing circuitry to perform any of the methods described earlier. The computer program thus provides the advantages discussed earlier in respect of the method of using a trained model with a software installation process and the method of using a trained model with a software installation process.

According to another aspect of the idea, there is provided a computer program product, embodied on a non-transitory machine-readable medium, comprising instructions which are executable by processing circuitry to cause the processing circuitry to perform the method as described earlier. The computer program product thus provides the advantages discussed earlier in respect of the method of using a trained model with a software installation process and the method of using a trained model with a software installation process.

Therefore, an improved technique for troubleshooting software installation process failures is provided.

### BRIEF DESCRIPTION OF THE DRAWINGS

For a better understanding of the idea, and to show how it may be put into effect, reference will now be made, by way of example, to the accompanying drawings, in which:

FIG. 1 is a block diagram illustrating a system according to an embodiment;

FIG. 2 is a block diagram illustrating a method according to an embodiment;

FIG. 3 is a block diagram illustrating a system according to an embodiment;

FIG. 4 is a block diagram illustrating a method according to an embodiment;

FIG. 5 is a block diagram illustrating a system according to an embodiment;

FIG. 6 is a block diagram illustrating a system according to an embodiment;

FIG. 7 is a block diagram illustrating a system according to an embodiment;

FIG. 8 is a block diagram illustrating a system according to an embodiment;

FIG. 9 is a block diagram illustrating a system according to an embodiment; and

FIG. 10 is a block diagram illustrating a system according to an embodiment.

### DETAILED DESCRIPTION

As mentioned earlier, there is described herein an improved technique for troubleshooting software installation process failures. Herein, a software installation process can be any process for installing software. Examples of software to which the technique may be applicable include, but are not limited to, Cloud Container Distribution (CCD) software, Cloud Execution Environment (CEE) software, or any other software, or any combination of software.

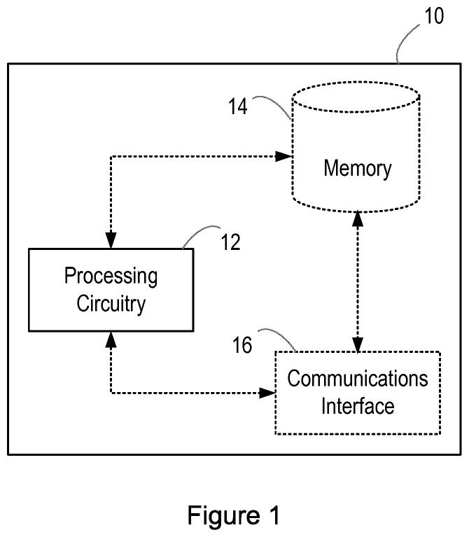

FIG. 1 illustrates a system 10 in accordance with an embodiment. Generally, the system 10 is configured to operate to train a model for use with a software installation process. The model referred to herein can be a classifier, such as a classifier that uses multi-label classification. In some embodiments, the model referred to herein may comprise a correlation matrix, a model of neural network (or a neural network model), or any other type of model that can be trained in the manner described herein.

As illustrated in FIG. 1, the system 10 comprises processing circuitry (or logic) 12. The processing circuitry 12 controls the operation of the system 10 and can implement the method of training a model for use with a software installation process described herein. The processing circuitry 12 can comprise one or more processors, processing units, multi-core processors or modules that are configured or programmed to control the system 10 in the manner described herein. In particular implementations, the processing circuitry 12 can comprise a plurality of software and/or hardware modules that are each configured to perform, or are for performing, individual or multiple steps of the method described herein.

Briefly, the processing circuitry 12 of the system 10 is configured to run a software installation process a plurality of times and, each time the software installation process is run, change one parameter in a set of parameters with which the software installation process is run to generate a respective software installation process output. The processing circuitry 12 of the system 10 is also configured to use each software installation process output with its respective set of parameters to train (or adapt) a model. Specifically, the model is trained (or adapted) to identify one or more parameters that are a cause of a failed software installation process based on the output of the failed software installation process.

As illustrated in FIG. 1, the system 10 may optionally comprise a memory 14. The memory 14 of the system 10 can comprise a volatile memory or a non-volatile memory.

In some embodiments, the memory 14 of the system 10 may comprise a non-transitory media. Examples of the memory 14 of the system 10 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the system 10 can be connected to the memory 14 of the system 10. In some embodiments, the memory 14 of the system 10 may be for storing program code or instructions which, when executed by the processing circuitry 12 of the system 10, cause the system 10 to operate in the manner described herein to train a model for use with a software installation process. For example, in some embodiments, the memory 14 of the system 10 may be configured to store program code or instructions that can be executed by the processing circuitry 12 of the system 10 to perform the method of training a model for use with a software installation process described herein.

Alternatively or in addition, the memory 14 of the system 10 can be configured to store any requests, responses, indications, information, data, notifications, signals, or similar, that are described herein. The processing circuitry 12 of the system 10 may be configured to control the memory 14 of the system 10 to store any requests, responses, indications, information, data, notifications, signals, or similar, that are described herein. In some embodiments, for example, the processing circuitry 12 of the system 10 may be configured to control the memory 14 of the system 10 to store any one or more of the software installation process, the set of parameters, one or more changed parameters in the set of parameters, the software installation process output, and the trained (or adapted) model.

In some embodiments, as illustrated in FIG. 1, the system 10 may optionally comprise a communications interface 16. The communications interface 16 of the system 10 can be connected to the processing circuitry 12 of the system 10 and/or the memory 14 of the system 10. The communications interface 16 of the system 10 may be operable to allow the processing circuitry 12 of the system 10 to communicate with the memory 14 of the system 10 and/or vice versa. The communications interface 16 of the system 10 can be configured to transmit and/or receive any requests, responses, indications, information, data, notifications, signals, or similar, that are described herein. In some embodiments, the processing circuitry 12 of the system 10 may be configured to control the communications interface 16 of the system 10 to transmit and/or receive any requests, responses, indications, information, data, notifications, signals, or similar, that are described herein.

Although the system 10 is illustrated in FIG. 1 as comprising a single memory 14, it will be appreciated that the system 10 may comprise at least one memory (i.e. a single memory or a plurality of memories) 14 that operate in the manner described herein. Similarly, although the system 10 is illustrated in FIG. 1 as comprising a single communications interface 16, it will be appreciated that the system 10 may comprise at least one communications interface (i.e. a single communications interface or a plurality of communications interface) 16 that operate in the manner described herein.

It will also be appreciated that FIG. 1 only shows the components required to illustrate an embodiment of the system 10 and, in practical implementations, the system 10 may comprise additional or alternative components to those shown.

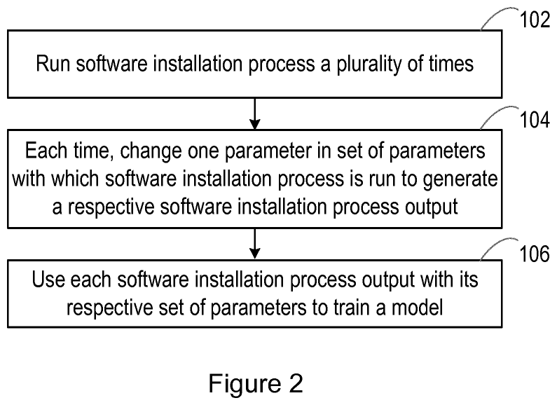

FIG. 2 is a flowchart illustrating a method of training a model for use with a software installation process in accordance with an embodiment. This method may, for example, be performed in a lab. The system 10 described earlier with reference to FIG. 1 is configured to operate in accordance with the method that will now be described with reference to FIG. 2. The method can be performed by or under the control of the processing circuitry 12 of the system 10.

With reference to FIG. 2, at block 102, a software installation process is run a plurality of times. More specifically, the processing circuitry 12 of the system 10 runs a software installation process is run a plurality of times. In some embodiments, the processing circuitry 12 of the system 10 may comprise an installer to run the software installation process. Herein, the software installation process may be a software installation process that is run for the first time or an upgrade of previously run software installation process. The software installation process may thus also be referred to as a lifecycle management process.

At block 104 of FIG. 2, each time the software installation process is run, one parameter in a set of parameters with which the software installation process is run is changed to generate a respective software installation process output. More specifically, each time the software installation process is run, the processing circuitry 12 of the system 10 changes one parameter in a set of parameters in this way. In some embodiments, a parameter modifier may be used to change one parameter in the set of parameters each time the software installation process is run. In some embodiments, each time the software installation process is run, the time that the software installation process takes to run may be stored (e.g. in the memory 14 of the system 10).

In some embodiments, the first time the software installation process is run, random parameters (e.g. values) may be used for all parameters in the set of parameters. In some embodiments, these random parameters may be set based on the type of parameter. For example, if the parameter is an Internet Protocol (IP) address, then the parameter with which the software installation process is first run may be a random IP address. In some embodiments, the set of parameters referred to herein may comprise one or more configuration parameters for the software installation process. In some embodiments, the set of parameters referred to herein may comprise one or more software parameters for the software installation process and/or one or more hardware parameters for the software installation process.

Each time the software installation process is run, the software installation process either succeeds or fails. In some embodiments, each of the generated software installation process outputs referred to herein can comprise an indication of whether the software installation process fails. For example, each of the generated software installation process outputs referred to herein can comprise an indication that the software installation process fails or an indication that the software installation process succeeds. In some embodiments, the generated software installation process outputs referred to herein may comprise a log file.

Although not illustrated in FIG. 2, in some embodiments, the method may comprise generating a label vector to represent the set of parameters. This label vector may, for example, comprises a plurality of (e.g. indexed) items. Each item can be representative of one parameter in the set of parameters. The position of each item in the label vector is indicative of which parameter that item represents. In some embodiments, each time one parameter in the set of parameters is changed, the item representative of the changed parameter in the set of parameters may have a first value and the items representative of all other parameters in the set of parameters may have a second value. In these embodiments, the second value is different to the first value. The first value and the second value can be binary values according to some embodiments. For example, the first value may be one, whereas the second value may be zero. In this way, it is possible to distinguish the parameter in the set of parameters that has changed from the other parameters in the set of parameters.

Thus, at block 104 of FIG. 2, the respective software installation process outputs are generated. Each software installation process output may be in a format that is processable by the model. However, where a software installation process output is not in a format that is processable by the model, the method may comprise converting the software installation process output into a format that is processable by the model, e.g. into a feature vector. For example, where a software installation process output is in a written format (which is not processable by the model), the method may comprise using text analysis (e.g. from a chatbot) to convert the software installation process output from a written format into a format that is processable by the model, e.g. into a feature vector. In some of these embodiments, each word of the software installation process output may be converted into a format that is processable by the model, e.g. into a number in the feature vector.

Thus, although not illustrated in FIG. 2, in some embodiments, the method may comprise converting each software installation process output into a feature vector. The feature vector may comprise a plurality of (e.g. indexed) items. Each item can be representative of a feature of the software installation process output. For example, where the software installation process output is in a written format, each item may be representative of a word from the software installation process output. In this way, a word dictionary can be created. The position of each item in the feature vector is indicative of which feature of the software installation process output that item represents. Each item in the feature vector can have a value indicative of whether the item represents a particular feature (e.g. word) of the software installation process output. For example, in some embodiments, each item representative of the particular feature (e.g. word) of the software installation process output may have a first value and each item representative of other features of the software installation process output may have a second value. In these embodiments, the second value is different to the first value. The first value and the second value can be binary values according to some embodiments. For example, the first value may be one, whereas the second value may be zero. A person skilled in the art will be aware of various techniques for converting an output (such as the output of the software installation process described here) into a feature vector. For example, a one-hot vector encoding technique may be used, a multi-hot vector encoding technique may be used, or any other technique for converting an output into a feature vector may be used.

The respective software installation process outputs that are generated at block 104 of FIG. 2 can comprise one or more failed software installation process outputs. In addition, in some embodiments, the respective software installation process outputs may comprise one or more successful software installation process outputs. Although not illustrated in FIG. 2, in some of these embodiments, the method may comprise filtering the failed software installation process outputs based on the successful software installation process outputs. For example, in the embodiments involving text analysis, the text analysis may include such filtering.

The failed software installation process outputs may be filtered to only pass software installation process outputs that appear to be an anomaly compared to the successful software installation process outputs. In this way, the successful installations can be used to build an anomaly detection database. If the failed software installation process outputs are filtered in the manner described, all non-anomalies can be filtered out. The anomalies which persist are not seen in any successful installation process outputs and are thus likely to include an indication for the cause of a failed software installation process. In some embodiments, the failed software installation process outputs that remain after the filtering may be output to a user so that the user may provide feedback to aid in identifying the one or more parameters that are a cause of a failed software installation process.

Although not illustrated in FIG. 2, in some embodiments, the method may comprise storing each software installation process output with its respective set of parameters. For example, the processing circuitry 12 of the system 10 can be configured to control at least one memory 14 of the system 10 to store each software installation process output with its respective set of parameters.

At block 106 of FIG. 2, each software installation process output is used with its respective set of parameters to train (or adapt) a model. More specifically, the processing circuitry 12 of the system 10 uses each software installation process output with its respective set of parameters to train (or adapt) a model. The model is trained (or adapted) to identify one or more parameters that are a cause of a failed software installation process based on the output of the failed software installation process. For example, where a software installation process runs successfully with an initial set of parameters and then runs unsuccessfully (i.e. fails) following a change to one of the parameters in the set of parameters, the model is trained to identify that the changed parameter is a cause of a failed software installation process. In this way, for a given output of a failed software installation process, the model is trained to recognise or predict which one or more parameters is the cause of the software installation process failure. The model may be trained using a machine learning algorithm or similar.

As described earlier, in some embodiments, a label vector comprising a plurality of items may be generated to represent the set of parameters and each software installation process output may be converted into a feature vector comprising a plurality of items. Thus, in these embodiments, each feature vector representative of a software installation process output can be used with the respective label vector representative of the set of parameters to train the model to identify one or more parameters that are a cause of a failed software installation process based on the output of the failed software installation process.

Although not illustrated in FIG. 2, in some embodiments, the method may comprise, in response to a failed software installation process, using the trained model to identify one or more parameters that are a cause of the failed software installation process based on the output of the failed software installation process.

Although also not illustrated in FIG. 2, in some embodiments, the method may comprise further training (or updating, tuning, or refining) the trained model based on feedback from a user (e.g. customer). For example, the feedback from the user may comprise an indication of a failed software installation process output with its respective set of parameters. Thus, faulty installations can be extracted from the configurations at the user (e.g. customer) side according to some embodiments. In these embodiments, the trained model may be further trained (or updated, tuned, or refined) using the failed software installation process output with its respective set of parameters. Thus, the model is trained to identify one or more parameters that are a cause of this failed software installation process as well. In some of these embodiments, the method can comprise, in response to a failed software installation process, using the further trained (or updated, tuned, or refined) model to identify one or more parameters that are a cause of the failed software installation process based on the output of the failed software installation process.

Thus, there is described an improved installation troubleshooting tool and a way to create model for such a tool. Training (e.g. machine learning) can be used on the model to correlate an output of a software installation process (e.g. a log file) to input data of the software installation process (i.e. the set of parameters described earlier). The training of the model is achieved by running a software installation several times with changed input data and using the input data with the respective output data to train the model, e.g. using a model training algorithm. In this way, the model can be trained to predict an error in a real failed software installation process.

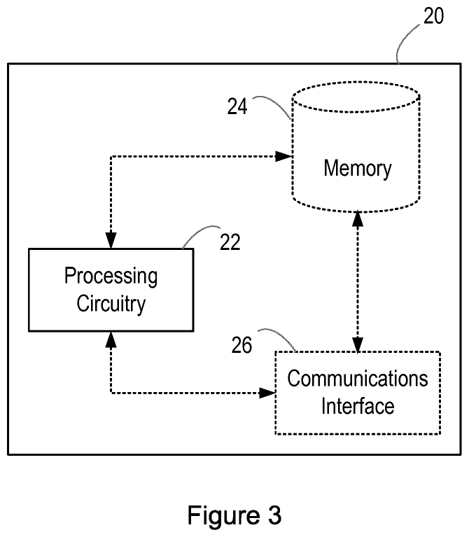

FIG. 3 illustrates a system 20 according in accordance with an embodiment. Generally, the system 20 is configured to operate to use a trained model with a software installation process. The trained model is a model that is trained in the manner described herein.

As illustrated in FIG. 3, the system 20 comprises processing circuitry (or logic) 22. The processing circuitry 22 controls the operation of the system 20 and can implement the method of using a trained model with a software installation process described herein. The processing circuitry 22 can comprise one or more processors, processing units, multi-core processors or modules that are configured or programmed to control the system 20 in the manner described herein. In particular implementations, the processing circuitry 22 can comprise a plurality of software and/or hardware modules that are each configured to perform, or are for performing, individual or multiple steps of the method described herein.

Briefly, the processing circuitry 22 of the system 20 is configured to run a software installation process with a set of parameters to generate an output and, in response to a failure of the software installation process, use a trained (or adapted) model to identify which one or more parameters in the set of parameters are a cause of the failed software installation process based on the output of the failed software installation process.

As illustrated in FIG. 3, the system 20 may optionally comprise a memory 24. The memory 24 of the system 20 can comprise a volatile memory or a non-volatile memory. In some embodiments, the memory 24 of the system 20 may comprise a non-transitory media. Examples of the memory 24 of the system 20 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 22 of the system 20 can be connected to the memory 24 of the system 20. In some embodiments, the memory 24 of the system 20 may be for storing program code or instructions which, when executed by the processing circuitry 22 of the system 20, cause the system 20 to operate in the manner described herein to use a trained model with a software installation process. For example, in some embodiments, the memory 24 of the system 20 may be configured to store program code or instructions that can be executed by the processing circuitry 22 of the system 20 to perform the method of using a trained model with a software installation process described herein.

Alternatively or in addition, the memory 24 of the system 20 can be configured to store any requests, responses, indications, information, data, notifications, signals, or similar, that are described herein. The processing circuitry 22 of the system 20 may be configured to control the memory 24 of the system 20 to store any requests, responses, indications, information, data, notifications, signals, or similar, that are described herein. In some embodiments, for example, the processing circuitry 22 of the system 20 may be configured to control the memory 24 of the system 20 to store any one or more of the software installation process, the set of parameters, the generated output, the failure of the software installation process, the trained model, and the one or more parameters identified to be a cause of the failed software installation process.

In some embodiments, as illustrated in FIG. 3, the system 20 may optionally comprise a communications interface 26. The communications interface 26 of the system 20 can be connected to the processing circuitry 22 of the system 20 and/or the memory 24 of the system 20. The communications interface 26 of the system 20 may be operable to allow the processing circuitry 22 of the system 20 to communicate with the memory 24 of the system 20 and/or vice versa. The communications interface 26 of the system 20 can be configured to transmit and/or receive any requests, responses, indications, information, data, notifications, signals, or similar, that are described herein. In some embodiments, the processing circuitry 22 of the system 20 may be configured to control the communications interface 26 of the system 20 to transmit and/or receive any requests, responses, indications, information, data, notifications, signals, or similar, that are described herein.

Although the system 20 is illustrated in FIG. 3 as comprising a single memory 24, it will be appreciated that the system 20 may comprise at least one memory (i.e. a single memory or a plurality of memories) 24 that operate in the manner described herein. Similarly, although the system 20 is illustrated in FIG. 3 as comprising a single communications interface 26, it will be appreciated that the system 20 may comprise at least one communications interface (i.e. a single communications interface or a plurality of communications interface) 26 that operate in the manner described herein.

It will also be appreciated that FIG. 3 only shows the components required to illustrate an embodiment of the system 20 and, in practical implementations, the system 20 may comprise additional or alternative components to those shown.

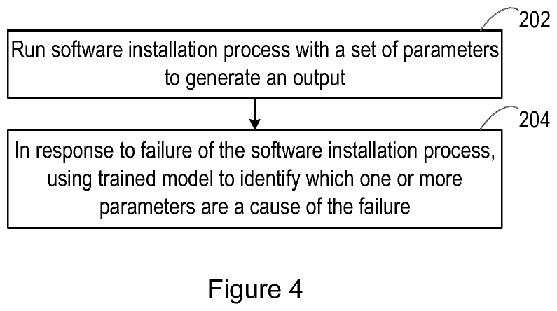

FIG. 4 is a flowchart illustrating a method of using a trained model with a software installation process in accordance with an embodiment. The system 20 described earlier with reference to FIG. 3 is configured to operate in accordance with the method that will now be described with reference to FIG. 4. The method can be performed by or under the control of the processing circuitry 22 of the system 20.

With reference to FIG. 4, at block 202, a software installation process is run with a set of parameters to generate an output. More specifically, the processing circuitry 22 of the system 20 runs a software installation with a set of parameters to generate an output. This software installation process is a real software installation process. It can be run by a user (e.g. a customer). In some embodiments, the processing circuitry 22 of the system 20 may comprise an installer to run the software installation process.

At block 204, in response to a failure of the software installation process, a trained (or adapted) model is used to identify which one or more parameters in the set of parameters are a cause of the failed software installation process based on the output of the failed software installation process. More specifically, in response to a failure of the software installation process, the processing circuitry 12 of the system 10 uses a trained (or adapted) model to identify which one or more parameters in the set of parameters are a cause of the failed software installation process based on the output of the failed software installation process. Thus, the output of the failed software installation process is input into the trained model. The output of the failed software installation process may thus also be referred to as the trained model input. This time, the model is not trained with the output of the failed software installation process. Instead, the already trained model is used to predict one or more parameters that may have caused the software installation process to fail based on the output of the failed software installation process.

In some embodiments, the output of the failed software installation process may comprise a log file. The output of the failed software installation process may be in a format that is processable by the trained model. However, where the output of the failed software installation process is not in a format that is processable by the trained model, the method may comprise converting the failed software installation process output into a format that is processable by the trained model, e.g. into a feature vector. For example, where a failed software installation process output is in a written format (which is not processable by the model), the method may comprise using text analysis (e.g. from a chatbot) to convert the failed software installation process output from a written format into a format that is processable by the model, e.g. into a feature vector. In some of these embodiments, each word of the failed software installation process output may be converted into a format that is processable by the model, e.g. into a number in the feature vector.

Thus, although not illustrated in FIG. 4, in some embodiments, the method may comprise converting the failed software installation process output into a feature vector. The feature vector may comprise a plurality of (e.g. indexed) items. Each item can be representative of a feature of the failed software installation process output. For example, where the failed software installation process is in a written format, each item may be representative of a word from the failed software installation process output. In this way, a word dictionary can be created. The position of each item in the feature vector is indicative of which feature of the failed software installation process output that item represents. Each item in the feature vector can have a value indicative of whether the item represents a particular feature (e.g. word) of the software installation process output. For example, in some embodiments, each item representative of the particular feature (e.g. word) of the failed software installation process output may have a first value and each item representative of other features of the failed software installation process output may have a second value. In these embodiments, the second value is different to the first value. The first value and the second value can be binary values according to some embodiments. For example, the first value may be one, whereas the second value may be zero. A person skilled in the art will be aware of various techniques for converting an output (such as the output of the failed software installation process described here) into a feature vector. For example, a one-hot vector encoding technique may be used, a multi-hot vector encoding technique may be used, or any other technique for converting an output into a feature vector may be used.

In some embodiments, the trained model may identify which one or more parameters in the set of parameters are a cause of the failed software installation process based on the output of the failed software installation process by comparing the output of the failed software installation process to the software installation process outputs used to train the model and identifying which of these software installation process outputs used to train the model is the same as or is most similar to (e.g. differs the least from) the output of the failed software installation process. The respective set of parameters of the identified software installation process output is thus the output of the trained model in these embodiments.

In some embodiments, the method may comprise generating a label vector to represent the set of parameters. That is, in some embodiments, the trained model may generate a label vector. The label vector may comprise a plurality of (e.g. indexed) items. Each item may be representative of a parameter in the set of parameters. The position of each item in the label vector is indicative of which parameter that item represents. Each item representative of a parameter may have a value indicative of whether the parameter causes the software installation process to fail. For example, in some embodiments, each item representative of a parameter in the set of parameters that causes the software installation process to fail may have a first value and each item representative of other parameters in the set of parameters (i.e. those parameters in the set of parameters that do not cause the software installation process to fail) may have a second value. In these embodiments, the second value is different to the first value. The first value and the second value can be binary values according to some embodiments. For example, the first value may be one, whereas the second value may be zero. In this way, it is possible to identify which one or more parameters in the set of parameters are a cause of the failed software installation process based on the output of the failed software installation process.

Alternatively or in addition, in some embodiments, the trained model may be used to indicate a probability that the one or more identified parameters are the cause of the failed software installation process based on the output of the failed software installation process. Thus, in embodiments where the trained model generates a label vector to represent the set of parameters, the label vector may comprise a plurality of (e.g. indexed) items and each item representative of a parameter in the set of parameters can have a value indicative of a probability that the parameter causes the software installation process to fail. The probability can be a percentage. For example, a value of 0 may be indicative of a 0% probability that a parameter causes the software installation process to fail, a value of 0.1 may be indicative of a 10% probability that a parameter causes the software installation process to fail, a value of 0.2 may be indicative of a 20% probability that a parameter causes the software installation process to fail, a value of 0.3 may be indicative of a 30% probability that a parameter causes the software installation process to fail, and so on up to a value of 1, which may be indicative of a 100% probability that a parameter causes the software installation process to fail. In this way, for each parameter in the set of parameters, the probability that the parameter is a cause of the failed software installation process can be provided.

Examples of label vectors that the trained model may generate are provided below:

| | Label vector | Label vector |
|---|---|---|
| | representing | representing |
| | which parameter | probability that |
| Parameter | caused failure | parameter caused fail |
| P1 | 0 | 0 |
| P2 | 0 | 0.3 |
| P3 | 0 | 0 |
| P4 | 1 | 0.7 |
| P5 | 0 | 0 |

Thus, according to above example, the parameter P4 is identified by the trained model to be a cause of a software installation process failure. More specifically, according to this example, the trained model identifies that the probability that the parameter P4 is the cause of the software installation process failure is 70% (while the probability that the parameter P2 is the cause of the software installation process failure is 30%).

Although not illustrated in FIG. 4, in some embodiments, the method may comprise causing an indication to be output (e.g. to a user). The indication can be indicative of the output of the trained model, i.e. the one or more identified parameters and/or the probability that the one or more parameters are a cause of the failed software installation process. The processing circuitry 22 of the system 20 may control the communications interface 26 to output the indication. In some embodiments, the indication may be rendered, e.g. by displaying the output on a screen. The indication can be in any form that is understandable to a user. In some embodiments (e.g. where the trained model generates a label vector as the output), the output of the trained model can be converted into a form that is understandable to a user. For example, the label vector may be converted into a user readable indication of the one or more identified parameters. This can, for example, be in the form of words indicating the one or more identified parameters, highlighting the one or more identified parameters in the set of parameters (e.g. in an original file, such as an original configuration file, an original software file, or an original hardware file), etc. Similarly, for example, this can be in the form of one or more numbers (e.g. one or more percentages) indicating the probability that the one or more parameters are a cause of the failed software installation process.

Herein, the failed software installation process may be a failed software installation process that is run for the first time or a failed upgrade of previously run software installation process. The failed software installation process may thus also be referred to as a failed lifecycle management process.

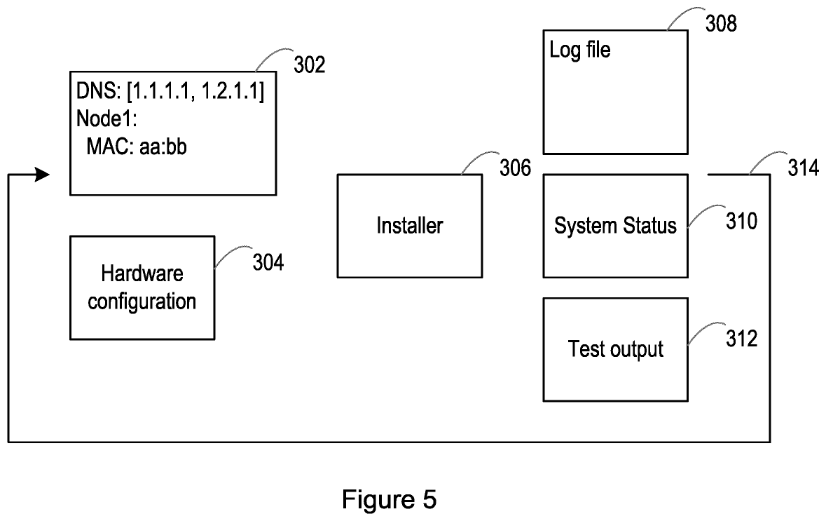

FIG. 5 is a block diagram illustrating a system according to an embodiment. In more detail, FIG. 5 illustrates a simplified architecture for a software installation process and a desired back projection. A set of parameters 302, 304 are provided so that the software installation process can be run to install a software product. For example, as illustrated in FIG. 5, the set of parameters 302, 304 may comprise software configuration parameters 302 and hardware configuration parameters 304.

In this example, the software installation process is run by an installer 306. The installer 306 generates an output, e.g. a log file 308 (which may present events while the software installation process is running), a system status 310 (e.g. which may represent the state of the system after running the software installation process), and/or a test output 312 (which may show that all features are active as expected). If the software installation process fails (e.g. due to one or more faulty parameters 302, 304), an indication of this failure can be visible in the output generated by the installer 306 (e.g. in the log file 308, system status 310 and/or test output 312).

The model described herein is trained to identify (or indicate) 314 one or more parameters that cause such a software installation process to fail. More specifically, with regard to the example architecture illustrated in FIG. 5, the model described herein can be trained to find a correlation in the output generated by the installer 306 in order to predict which parameter(s) 302, 304 may have caused the failure of the software installation process.

In an example, a software installation process uses an external Domain Name System (DNS) server Internet Protocol (IP) as a configuration parameter. There is no way to predict if this IP address is correct. All customers have different DNS servers in their Cloud infrastructures. As such, it is necessary to test (e.g. with a pre-check) if the DNS server is reachable and provides name resolution. This can be a complex procedure because, for every parameter in the configuration, it is necessary to program such a pre-check by hand. In addition, the pre-check can fail if the DNS server is not capable of resolving certain names. A large amount of scripting is also needed to check all circumstances which may cause the software installation process to fail. Also, if the software product changes, these pre-checks need to be adjusted. On the other hand, it is easy to see that a name resolution is not working when installing the software. By training a model in the manner described herein, it is possible to more easily, more quickly, and correctly predict from the output of the software installation process (e.g. from the log file 308) the parameter(s) 302, 304 (e.g. the wrong configuration) that causes the software installation to process to fail.

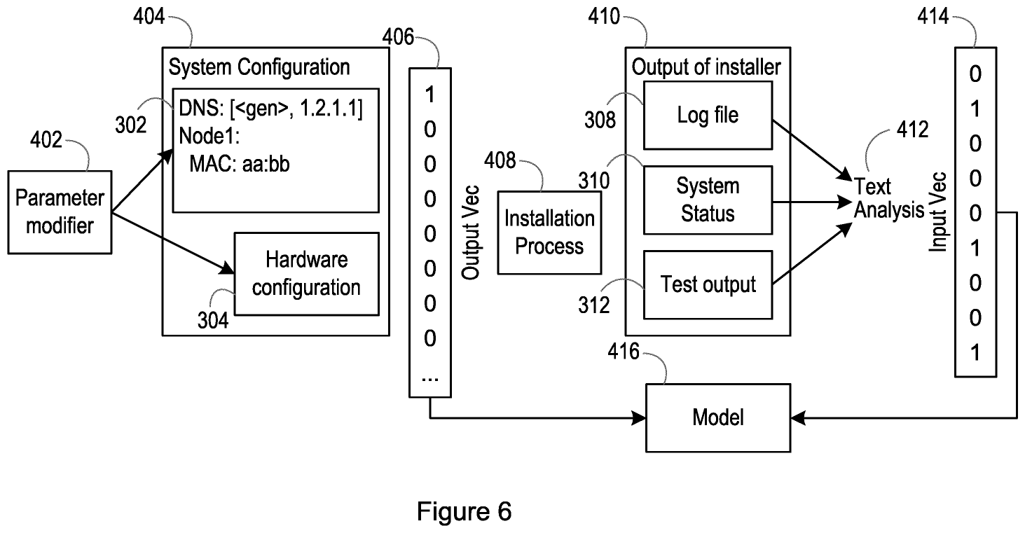

FIG. 6 is a block diagram illustrating a system according to an embodiment. More specifically, FIG. 6 illustrates an example of a system in which the method of training a model for use with a software installation process is implemented, as described earlier with reference to FIG. 2.

In the example system illustrated in FIG. 6, a parameter modifier 402 is used to change one parameter in the set of parameters 404 each time the software installation process 408 is run. In this example, the set of parameters comprise a set of system configuration parameters 404. The system configuration parameters comprise software configuration parameters 302 and hardware configuration parameters 304. A template (or a default) set of parameters 404 can be provided to an installer for the installer to run a successful software installation process 408. The installer provides an output 410 of the software installation processes 408 that it runs, e.g. any one or more of a log file 308, a system status 310 and a test output 312 as described earlier with reference to FIG. 5.

As described earlier with reference to blocks 102 and 104 of FIG. 2, a software installation process 408 is run a plurality of times and, each time the software installation process 408 is run, one parameter in the set of parameters 404 with which the software installation process 408 is run is changed to generate a respective software installation process output 410. The software installation process 408 can be run by an installer (e.g. installer 306 as illustrated in FIG. 5) and the output of the installer is the software installation process output 410. In this example, the parameter modifier 402 has the task of changing one parameter in the set of parameters 404 each time the software installation process 408 is run. The parameter modifier 402 may produce a slightly changed system configuration in order to change a parameter in the set of parameters 404. The changing of a parameter in the set of parameters 404 is performed in order to invoke an error (e.g. in a lab environment prior to delivering a software product to a user), such that a model 416 (e.g. a model of a neural network) can be trained in the manner described earlier with reference to block 106 of FIG. 2. This trained model 416 can be provided to the user.

As described earlier, a label vector 406 can be generated to represent the set of parameters 404. This label vector 406 may be referred to as the output vector (“Output Vec”) of the model 416. As illustrated in FIG. 6, this label vector 406 can comprise a plurality of (e.g. indexed) items. Each item can be representative of one parameter in the set of parameters 404. The position of each item in the label vector 406 is indicative of which parameter that item represents. As described earlier, in some embodiments, each time one parameter in the set of parameters 404 is changed, the item representative of the changed parameter in the set of parameters 404 may have a first value and the items representative of all other parameters in the set of parameters 404 may have a second value, which is different to the first value. In the embodiment illustrated in FIG. 6, the first value and the second value are binary values. Specifically, the first value is one, whereas the second value is zero. Initially, the label vector is filled with the second value (i.e. zeros) for each parameter in the set of parameters 404 and, each time one parameter in the set of parameters 404 is changed, the item representative of the changed parameter in the set of parameters 404 is changed to the first value (i.e. one). That is, the changed parameter that differs from the original template is marked, e.g. with a one, in the label vector 406. This can be called a one-hot vector.

When the software installation process 408 is run (e.g. by the installer 306 illustrated in FIG. 5) with this slightly changed label vector 406, the software installation process 408 either fails or succeeds and the software installation process output 410 is provided. This software installation process output 410 is transferred to the model 416 in a format which can be processed by the model. Where the output of the software installation process 410 is not in a format that is processable by the model 416, the software installation process output 410 can be converted into a format that is processable by the model 416. For example, as illustrated in FIG. 6, where a software installation process output 410 is in a written format, text analysis 412 may be used to convert the software installation process output 410 from the written format into a format that is processable by the model 416. In the example illustrated in FIG. 6, text analysis 412 is used to convert the software installation process output 410 into a feature vector 414 (“Input Vec”) as described earlier. That is, a feature vector 414 is generated. This feature vector 414 may be referred to as the input vector (“Input Vec”) of the model 416.

As illustrated in FIG. 6, the feature vector 414 can comprise a plurality of (e.g. indexed) items. Each item can be representative of a feature of the software installation process output 410. For example, where the software installation process output 410 is in a written format, each item may be representative of a word from the software installation process output 410. The position of each item in the feature vector 414 is indicative of which feature of the software installation process output 410 that item represents. Each item in the feature vector has a value indicative of whether the item represents a particular feature (e.g. word) of the software installation process output 410. As described earlier, in some embodiments, each item representative of the particular feature (e.g. word) may have a first value and each item representative of other features (e.g. words) may have a second value, which is different to the first value. In the embodiment illustrated in FIG. 6, the first value and the second value are binary values. Specifically, the first value is one, whereas the second value is zero. Each input (feature) vector 414 of the model 416 and the respective output (label) vector 406 of the model 416 may be saved and represent a dataset to train the model 416. That is, as described earlier with reference to block 106 of FIG. 2, each software installation process output 410 (which is converted into the input (feature) vector 414 in FIG. 6) is used with its respective set of parameters 404 (which is converted into the output (label) vector 406 of FIG. 6) to train a model 416. Specifically, as described earlier, the model 416 is trained to identify one or more parameters that are a cause of a failed software installation process based on the output of the failed software installation process. For example, where a software installation process runs successfully with an initial set of parameters and then runs unsuccessfully (i.e. fails) following a change to one of the parameters in the set of parameters, the model is trained to identify that the changed parameter is a cause of a failed software installation process. In this way, for a particular output of a failed software installation process, the trained model is able to recognise which one or more parameters is the cause the software installation process failure.

If the user runs into an installation fault not known to the system, feedback can be provided by the user as described earlier. A fault indicted by the feedback may be included in the parameter configuration. In this way, it can be guaranteed that the fault will not happen for other users. As described earlier, the trained model may be further trained based on feedback from a user.

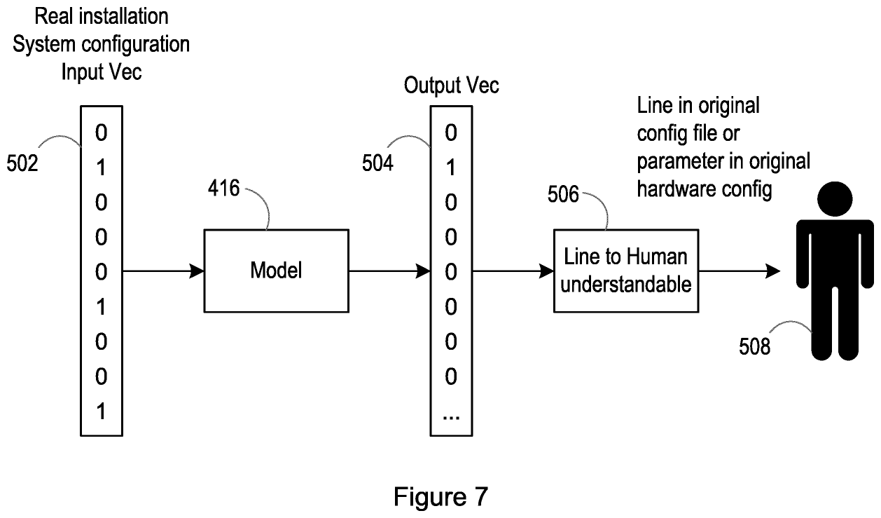

FIG. 7 is a block diagram illustrating a system according to an embodiment. More specifically, FIG. 7 illustrates an example of a system in which the method of using a trained model 416 with a software installation process 408 is implemented, as described earlier with reference to FIG. 4. In the example illustrated in FIG. 7, the model 416 (e.g. a model of a neural network) is trained in the manner described with reference to FIG. 6. The trained model 416 can be used to determine which one or more parameters are the cause of a failed software installation process (e.g. which one or more parameters of are faulty). The failure of the software installation process can occur at the site of a user (e.g. at a customer site).

As described earlier with reference to block 202 of FIG. 4, a software installation process is run with a set of parameters to generate an output. This software installation process is a real software installation process. It can be run by a user (e.g. a customer). The output generated by running the software installation process is provided to the trained model 416. In the example illustrated in FIG. 7, the output of the failed software installation process is converted (e.g. using text analysis as described earlier) into a feature vector 502. This feature vector 502 may be referred to as the input vector (“Input Vec”) of the trained model 416. The feature vector comprises a plurality of (e.g. indexed) items.

As described earlier with reference to block 204 of FIG. 4, in response to a failure of the software installation process, the trained model 416 is used to identify which one or more parameters in the set of parameters are a cause of the failed software installation process based on the output 502 of the failed software installation process. Thus, this time, the model 416 is not trained with the output 502 of the failed software installation process. Instead, the already trained model 416 is used to predict one or more parameters that caused the software installation process to fail, based on the output 502 of the failed software installation process. This is possible since the model 416 has been trained (in the manner described earlier) to recognise which one or more parameters cause a software installation process to fail based on the particular output that results from running the software installation process. More specifically, the trained model 416 is used to predict the output (label) vector 504 (“Output Vec”). Thus, in the embodiment illustrated in FIG. 7, the trained model 416 generates a label vector 504. The label vector 504 comprises a plurality of (e.g. indexed) items. Each item is representative of a parameter in the set of parameters and has a value indicative of whether the parameter causes the software installation process to fail. The position of each item in the label vector 504 is indicative of which parameter that item represents.

Each item representative of a parameter in the set of parameters that causes the software installation process to fail has a first value and each item representative of other parameters in the set of parameters (i.e. those parameters in the set of parameters that do not cause the software installation process to fail) has a second value, which is different to the first value. In the example illustrated in FIG. 7, the first value and the second value are binary values. More specifically, the first value is one, whereas the second value is zero. That is, any parameter in the set of parameters that causes the software installation process to fail is represented by an item having a value of one and any other parameters in the set of parameters are represented by an item having a value of zero. Thus, the trained model 416 identifies any parameter in the set of parameters represented by an item having a value of one as the one or more parameters in the set of parameters that are a cause of the failed software installation process.

In some embodiments, the trained model 416 may be used to indicate a probability that the one or more identified parameters are the cause of the failed software installation process based on the output of the failed software installation process. Thus, in embodiments where the trained model generates a label vector, the label vector may comprise a plurality of (e.g. indexed) items and each item representative of a parameter in the set of parameters can have a value indicative of a probability that the parameter causes the software installation process to fail. The probability can be a percentage as described earlier. For example, in the embodiment illustrated in FIG. 7, the item having a value of one can be indicative that there is 100% probability that the parameter represented by that item is the parameter that causes the software installation process to fail.

In the example embodiment illustrated in FIG. 7, an indication indicative of the output of the trained model 416 (i.e. indicative of the one or more identified parameters and/or the probability that the one or more parameters are a cause of the failed software installation process) is output to a user 508. The indication can be in any form that is understandable to a user. In the example illustrated in FIG. 7, where the trained model 416 generates a label vector 504 as the output, the output of the trained model 416 can be converted into a form that is understandable to a user. For example, the label vector may be converted into a user readable indication 506 of the one or more identified parameters, as described earlier.

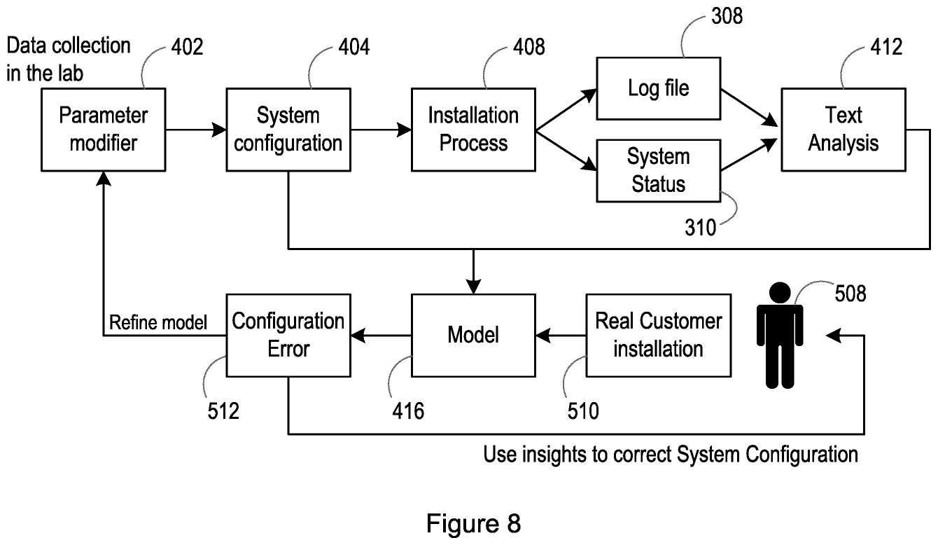

FIG. 8 is a block diagram illustrating a system according to an embodiment. More specifically, FIG. 8 illustrates an example of a system in which the method of training a model 416 for use with a software installation process 408 is implemented (as described earlier with reference to FIGS. 2 and 6) and the method of using a trained model 416 with a software installation process 408 is implemented (as described earlier with reference to FIGS. 4 and 7). Thus, FIG. 8 illustrates an end-to-end application. Blocks 402, 404, 408, 308, 310, 412 and 416 are as described earlier with reference to FIG. 6 and thus the corresponding description will be understood to also apply to FIG. 8.

In addition, in the example illustrated in FIG. 8, if the trained model 416 is unable to identify the one or more parameters that are a cause of a failed software installation process, the parameter modifier 402 is adjusted as described earlier. Thus, in some embodiments such as that illustrated in FIG. 8, the model 416 may output an error (e.g. a configuration error) 512 to a user 508. In response to the error, the user 508 may provide feedback 510. The feedback from the user may comprise an indication of a failed software installation process output with its respective set of parameters.

The feedback may describe a fault well enough such that the fault can be simulated (e.g. in the lab). As described earlier, the trained model 416 can be further trained based on feedback 510 from the user 508. In this way, the trained model 416 can be refined (or fine-tined) to thereby improve the reliability of the method in identifying one or more parameters that are a cause of the failed software installation process is improved. Moreover, it can be guaranteed that the cause of that same fault can be identified to other users.

It may be that a parameter that causes a software installation process to fail in an early stage is uncorrelated to a parameter that causes the software installation process to fail in a later stage. In addition, there may be parameters that are either correct (and the software installation process is successful) or wrong (and the software installation process fails). For example, a media access control (MAC) address needs to always be exact, otherwise the software installation process will fail. However, in either case, the error that results from software installation process failure may always be similar, e.g. “node 20 is not coming up”. Thus, it is relatively easy for the trained model described herein to identify one or more parameters that are a cause of a failed software installation process.

The method described herein of training a model and/or the method described herein of using the trained model can be automated. The method described herein of training the model can be used to build a single point of knowledge, which can indicate all possible parameters that may be the cause of a failed software installation process (e.g. while the software installation process is run).

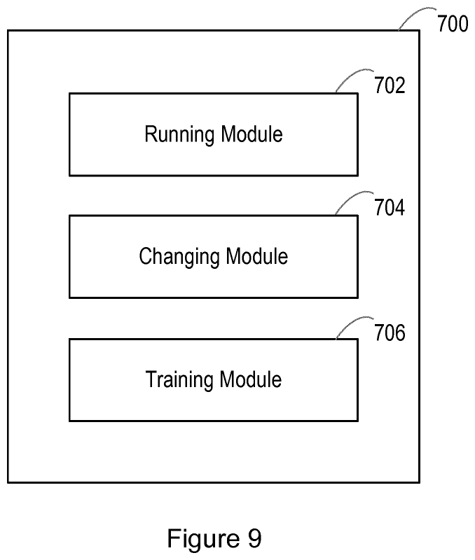

FIG. 9 is a block diagram illustrating a system 700 in accordance with another embodiment. The system 700 comprises a running module 702 configured to run a software installation process a plurality of times. The system 700 comprises a changing module 704 configured to, each time the software installation process is run, change one parameter in a set of parameters with which the software installation process is run to generate a respective software installation process output. The system 700 comprises a training module 706 configured to use each software installation process output with its respective set of parameters to train a model. The model is trained to identify one or more parameters that are a cause of a failed software installation process based on the output of the failed software installation process. The system 700 may operate in the manner described herein in respect of training a model for use with a software installation process.

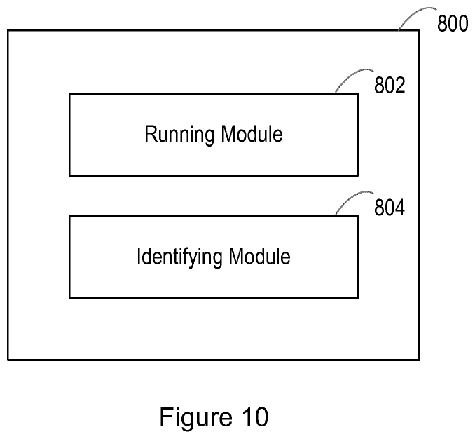

FIG. 10 is a block diagram illustrating a system 800 in accordance with another embodiment. The system 800 comprises a running module 802 configured to run a software installation process with a set of parameters to generate an output. The system 800 comprises an identifying module 804 configured to, in response to a failure of the software installation process, use a trained model to identify which one or more parameters in the set of parameters are a cause of the failed software installation process based on the output of the failed software installation process. The system 800 may operate in the manner described herein in respect of using a trained model with a software installation process.

The system functionality described herein can be performed by hardware. Thus, any one or more of the systems 10, 20 described herein can be a hardware system.

However, it will also be understood that at least part or all of the system functionality described herein can be virtualized. For example, the functions performed by any one or more of the systems 10, 20 can be implemented in software running on generic hardware that is configured to orchestrate the system functionality. Thus, in some embodiments, any one or more of the systems 10, 20 can be a virtual system.

In some embodiments, at least part or all of the system functionality described herein may be performed in a network enabled cloud. The system functionality described herein may all be at the same location or at least some of the system functionality may be distributed.

It will be understood that at least some or all of the method steps described herein can be automated according to some embodiments. That is, in some embodiments, at least some or all of the method steps described herein can be performed automatically. As such, an automated method of training a model for use with a software installation process can be provided according to some embodiments.

Similarly, an automated method of using a trained model with a software installation process can be provided according to some embodiments.

There is provided a computer program comprising instructions which, when executed by processing circuitry (such as the processing circuitry 12 of the system 10 or the processing circuitry 22 of the system 20 described earlier), cause the processing circuitry to perform at least part of the method described herein. There is provided a computer program product, embodied on a non-transitory machine-readable medium, comprising instructions which are executable by processing circuitry (such as the processing circuitry 12 of the system 10 or the processing circuitry 22 of the system 20 described earlier) to cause the processing circuitry to perform at least part of the method described herein. There is provided a computer program product comprising a carrier containing instructions for causing processing circuitry (such as the processing circuitry 12 of the system 10 or the processing circuitry 22 of the system 20 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

The idea described herein introduces an innovative method to train a model for use with a software installation process and an innovative method to use the trained model with a software installation process. The method described herein for training a model can be repeated with various changes to the parameters with which the software installation process is run (e.g. with large variations in the system configuration parameters) in order to produce various datasets that can then be used to train the model. Thus, in the manner described, there is advantageously provided an improved technique for troubleshooting software installation process failures.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-25. (canceled)

26. A method comprising:
running a software installation process a plurality of times, the software installation process dependent on a set of parameters and wherein each running results in a respective software installation process output and is based on changing a single parameter in the set of parameters, such that each running has a corresponding parameter set; and
training a machine-learning model by executing a model training algorithm that uses the respective software installation process outputs and the corresponding parameter sets, by which the machine-learning model learns correlations between respective ones of parameters and failures of the software installation process.

27. The method of claim 26, further comprising using the machine-learning model to identify which one or more parameters in the set of parameters are most likely the cause of failure in a subsequent failed running of the software installation process.

28. The method of claim 26, the method further comprising generating a label vector to represent the set of parameters.

29. The method of claim 28, wherein the label vector comprises a plurality of items, each item representative of a parameter in the set of parameters.

30. The method of claim 29, wherein each time one parameter in the set of parameters is changed, the item representative of the changed parameter in the set of parameters has a first value and the items representative of all other parameters in the set of parameters have a second value, wherein the second value is different than the first value.

31. The method of claim 26, the method further comprising converting each software installation process output into a feature vector.

32. The method of claim 31, wherein the feature vector comprises a plurality of items, each item representative of a feature of the software installation process output and having a value indicative of whether the item represents a particular feature of the software installation process output.

33. The method of claim 32, wherein each item representative of the particular feature of the software installation process output has a first value and each item representative of other features of the software installation process output has a second value, wherein the second value is different than the first value.

34. The method of claim 26, wherein the machine-learning model is further trained to indicate probabilities that a particular one or ones among the respective parameters are associated with a given failure of the software installation process.

35. The method of claim 26, the method further comprising further training the machine-learning model based on feedback from a user, wherein the feedback from the user comprises an indication of a failure of the software installation process and the corresponding parameter set.

36. The method of claim 26, wherein running the software installation process a plurality of times results in a mix of installation failures and installation successes, and wherein the method further comprises filtering the respective software installation process outputs for the installation failures, based on the respective software installation outputs for the installation successes.

37. The method of claim 26, wherein running the software installation process comprises running a new installation process or an upgrade process.

38. A system for training a machine-learning model for use with a software installation process, the system comprising:
processing circuitry; and
at least one memory for storing instructions which, when executed by the processing circuitry, cause the system to:
run the software installation process a plurality of times, the software installation process dependent on a set of parameters and wherein each running results in a respective software installation process output and is based on changing a single parameter in the set of parameters, such that each running has a corresponding parameter set; and
training the machine-learning model by executing a model training algorithm that uses the respective software installation process outputs and the corresponding parameter sets, by which the machine-learning model learns correlations between respective ones of parameters and failures of the software installation process.

39. A method of using a trained machine-learning model with a software installation process, the trained model trained to identify correlations between failures of the software installation process and respective parameters with which the software installation process is run, the method comprising:
running the software installation process with a set of parameters, resulting in a respective software installation process output that depends on the set of parameters; and
in response to a failure of the software installation process:
using the trained machine-learning model with the respective software installation process output, to identify which one or more parameters in the set of parameters caused the failure.

40. The method of claim 39, wherein the trained machine-learning model generates a label vector comprising a plurality of items, each item representative of a parameter in the set of parameters and having a value indicative of whether the parameter caused the software installation process to fail.

41. The method of claim 39, wherein the trained machine-learning model indicates a probability that a particular one or one of the respective parameters caused the failure.

42. The method of claim 41, wherein the trained machine-learning model generates a label vector comprising a plurality of items, each item representative of a respective parameter in the set of parameters and having a value indicative of a probability that the respective parameter caused the software installation process to fail.

43. A system for using a trained machine-learning model with a software installation process, the trained model trained to identify correlations between failures of the software installation process and respective parameters with which the software installation process is run, and the system comprising:
processing circuitry; and
at least one memory for storing instructions which, when executed by the processing circuitry, cause the system to:
run the software installation process with a set of parameters, resulting in a respective software installation output that depends on the set of parameters; and
in response to a failure of the software installation process:
use the trained model with the respective software installation output, to identify which one or more parameters in the set of parameters are a cause of the failure.
